(19) United States
(12) Patent Application Publication
(10) Pub. No.: US 2026/0124533 A1
(43) Pub. Date: May 7, 2026

(54) GAMEPLAY INPUT TIMER TRAINING TO REINFORCE MUSCLE MEMORY

(71) Applicant: Sony Interactive Entertainment Inc., Tokyo (JP)

(72) Inventors: Andrew Herman, San Mateo, CA (US); Travis Baurmann, San Mateo, CA (US)

(21) Appl. No.: 18/937,989

(22) Filed: Nov. 5, 2024

(51) Int. Cl. A63F 13/42; A63F 13/44; A63F 13/493; A63F 13/5375; A63F 13/798

(52) U.S. Cl. CPC A63F 13/42; A63F 13/44; A63F 13/493; A63F 13/5375; A63F 13/798; A63F 2300/638

(57) ABSTRACT

Methods and systems are disclosed to provide assistance to a player by providing practice game scenarios that replicate a key event that the player finds difficult to complete and a timing requirement within which the achieve the key event. The practice game scenarios are customized for the player and are based on input skills acquired by the player during different gameplay sessions. Along with the practice game scenario several tools are provided to assist the player to achieve their goal of mastering the inputs for the video game.

### BACKGROUND OF THE INVENTION

### 1. Field of the Invention

The present disclosure relates to providing assistance to a user in gameplay of a video game, and more specifically, providing practice game scenarios with help interface to provide visual control inputs for the user to practice their input skills prior to gameplay of the video game.

### 2. Description of the Related Art

Video gaming industry has grown in popularity and represents a large percentage of the entertainment market and interactive content generated worldwide. Various types of video games are available for playing. There are single-player video games and multi-player video games. In the case of multi-player video games, the users can play individually against one another or can be part of a team of users playing against at least one other second team. Further, the users of the multi-player video games can be co-located or remotely located from one another. A player can select a video game for game play and provide game inputs used to affect a game state of the video game and to update game content. The updated game content includes game scenes that are returned to client device of the player for rendering. In the case of the multi-player video game, the game inputs of the different players are used to affect the game state and to synchronize the game content generated and returned to the client devices associated with the different players.

When a player is engaged in watching a recorded video of gameplay of a video game, it is easier to follow the type and sequence of game inputs that is required to accomplish a task in a game scene. However, when the player has to actually provide the game inputs, the player may experience difficulty in providing the types or sequences of game inputs or at a speed that is necessary to accomplish the task. The difficulty may be due to the player not being able to recall the sequence or combinations (e.g., sequential vs. non-sequential, single press vs. multiple presses, etc.,) of game inputs or due to the passage of time since the player last played the video game. As the amount of time since the player last played the video game increases, the potential for muscle memory loss also increases. Analysis of the gameplay history of the video game maintained for the player can be used to determine if the player is experiencing difficulty due to being unable to recall the sequence or combinations or due to lacking the dexterity for providing the type, sequence or combination of the game inputs expected in certain sections of the video game in the prior gameplay sessions or due to passage of time between video game playing sessions. In some cases, the player may be able to accomplish the task using a specific type or sequence of inputs but there can be alternate ways of providing the game inputs that are better, faster, or simpler that the player is not aware of. The lack of the skill set required to navigate the challenging tasks in the video game can lead to frustration and disappointment in the player and drive the player away from the video game.

It is in this context that embodiments of the invention arise.

### SUMMARY OF THE INVENTION

Implementations of the present disclosure relate to systems and methods for providing a mechanism to assist a player of a video game to remember or recall inputs required to progress in the video game. The player may be accessing the video game for gameplay after an extended period of time. Consequently, the player may have forgotten the types, sequence, and timing of game inputs required to progress in the video game. Alternately, looking at the history of gameplay of the player may indicate that the player is having difficulty in certain sections of the video game - specifically certain types, sequence and/or timings of game inputs. The mechanism may be used to determine a portion where the player needs assistance in improving their game input skills and provide the player with an option to improve their game input skills in that portion. The portion of the gameplay may be identified to be where the player had difficulty progressing or where the player had left off in a previous gameplay session and may include one or more game events and/or game tasks that need to be completed or accomplished.

The player is presented with a game scenario that includes one or more game events that are similar in scope or complexity or context to the game events that were identified within the portion of the video game where the player had previously attempted and had difficulty and needed some assistance or practice. The game scenario is presented on a user interface for the player to select and practice their game input skills. The game interface may be presented to the player upon detecting a request for gameplay of the video game received from the player so that the player can practice their game input skills prior to tackling the actual video game. In addition to the game scenario, the user interface may also include an image of a controller showing the various input controls available and a visual representation of the different input controls to activate to complete/accomplish the game events/game tasks. The visual representation shows the type, the sequence, the timing of the different input controls for the player to follow. Depending on the progress made by the player in the video game, the one or more game events included in the game scenario presented to the player are similar in nature to a game event that the player had previously attempted in a prior gameplay session. Where the player has not made much progress in the video game, the game scenario may include a very basic event to allow the player to practice basic game inputs before the player embarks on playing the video game. The mechanism may be provided as an option for user selection. In some cases, the game scenario that the player is presented with is an event that the player has already attempted either successfully or unsuccessfully, so as to prevent spoiler alerts in the video game. The portion of the video game may be presented to the player prior to providing access to the video game for gameplay.

In one implementation, a method to allow a player to practice providing inputs to a video game is disclosed. The method includes analyzing gameplay of the player from one or more prior gameplay sessions of the video game to identify a portion of the gameplay where the player needs the practice to provide the inputs for a key event contained within. A practice game scenario designed to replicate the key event that the player needs to practice, is generated. The practice game scenario includes a timing requirement for completing the key event. The practice game scenario used to allow the player to practice providing the inputs. The practice game scenario is provided on a help interface for rendering on a screen of a client device used by the player to interact with the video game. The help interface includes information related to the inputs required to progress in the key event included within and a timer to track the inputs provided by the player meets the timing requirements specified for the key event within the practice game scenario.

In another implementation, a method is disclosed. The method includes monitoring inputs provided by a player for a key event included in a portion of a video game selected for gameplay by the player; detecting the player struggling to provide specific control inputs to complete the key event; generating a help interface with information about the specific control inputs required to complete the key event; and providing one or more practice game scenarios for the player to practice providing the specific control inputs. The one or more practice game scenarios are designed to replicate the portion of the video game where the player is detected to be struggling. The one or more practice game scenarios are provided to assist the player to practice in providing the specific control inputs required to complete the key event.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRAWINGS

The disclosure may be better understood by reference to the following description taken in conjunction with the accompanying drawings.

FIG. 1 represents a simplified block diagram of a system used to provide assistance to a player to improve providing inputs to a video game during gameplay, in accordance with one implementation.

FIG. 2 illustrates an example help interface used for providing gameplay practice options and post gameplay analysis of a player's gameplay, in some implementations.

FIG. 3A illustrates a help interface with a gameplay scenario identified for a player to practice game input skills, in accordance with one implementation.

FIGS. 3B-3D illustrate some help interfaces provided to a player to practice their game input skills, in accordance with some implementations.

FIG. 4 illustrates components of an example system that can be used to process audio signals generated for the user during gameplay of a video game, in accordance with one implementation.

### DETAILED DESCRIPTION

Broadly speaking, implementations of the present disclosure relate to providing help interface to assist a player to practice their game input skills prior to tackling different challenges within a video game. In some implementations, the help interface may be provided to the player to introduce the player to a new video game. A player can select a video game for gameplay and provide game inputs to progress in the video game. Based on the skill set acquired by the player, the player may be able to progress or may need some assistance to progress in the video game. The various implementations discussed herein disclose a system that is designed to continuously monitor the gameplay of the video game of the player and to recognize when the player is having difficulty providing the inputs. The difficulty in the gameplay can be determined upon detecting the player repeatedly failing to execute specific actions, frequently providing mistimed inputs, or otherwise struggling with input controls. The player can provide inputs to the video game using a controller or other input devices/interfaces and so the inputs provided by the player are alternately referred to as “game inputs” or “controller inputs”.

When the system detects the player's difficulty in providing the inputs in a certain portion of the video game, the system generates and forwards a help interface to a client device of the player for rendering on a display screen. The help interface is generated to include information about the certain portion of the video game including events, tasks and/or challenges that the player is having difficulty with, specific inputs (e.g., controller inputs) or sequences that are required to progress in the certain portion but are causing issues for the player, identifies one or more practice game scenarios that can assist the player in mastering the specific inputs so that the player has the necessary skill set to overcome the challenges or complete the tasks or events. The practice game scenarios are designed to replicate the events, tasks and/or challenges where the player struggled and needs practice. In some implementations, a practice game scenario may be identified for each event, task and/or challenge for which the player needs assistance. In alternate implementations, a practice game scenario may have more than one event, task and/or challenge for which the player needs assistance. Each game scenario requires the player to provide certain inputs, execute certain combinations accurately, and provide the inputs/combinations within certain time limit. These game scenarios are identified and provided to the player as targeted training exercises to improve the player's input skills in handling challenging sequences.

In some implementations, the time limit can be visually presented to the player in the form of a user interface (UI) element, such as a bar graph or a pie chart or an hour-glass or a countdown timer or a progress bar, etc., used to indicate the timing requirements and to track an amount of time left to provide the challenging sequence. The time-related UI element is provided alongside the game scenario to create a sense of urgency and to mimic the timing constraints of the actual game scenarios.

The system takes into consideration the complexity of the video game, the skill set acquired by the player during prior gameplay sessions, the skill set required to successfully complete the events/tasks/challenges in each portion of the video game, and provides appropriate practice game scenarios for the player to practice. In some cases, the system may break down the different challenges/events/tasks that are included in the certain portion of the video game that the player is struggling in, and present practice game scenarios for each challenge/event/task so as to allow the player to master the certain combination of game inputs required to complete that challenge/event/task. This way, the player can slowly build up the game input skills required to attempt a complex portion of the video game that may require a complicated set of inputs.

When the player has not played the video game for an extended period of time, the player may have lost the muscle memory that they had mastered in the video game. The practice game scenarios are specifically created to enable the player to regain their lost muscle memory. The practice game scenarios are generated specifically to coach the player to understand the correct way of providing the inputs (e.g., correct sequence or combination of button presses) and to improve the muscle memory that is necessary for fluid and precise control during actual gameplay of the video game. The system also provides prompt feedback using the results of the practice game scenarios to assist the player in understanding how their game inputs stack up against the game scenario requirements and, in some cases, against other players playing the same video games. By identifying the player needs assistance in the video game and proactively providing the player with practice game scenarios to sharpen their game input skills (i.e., muscle memory), the system ensures the player has a holistic and engaging learning experience that contributes to overall skill enhancement and enjoyment of the video game.

With the general understanding of the disclosure, specific implementations of the disclosure will now be described in greater detail with reference to the various figures. It should be noted that various implementations of the present disclosure can be practiced without some or all of the specific details. In other instances, well known process operations have not been described in detail in order not to unnecessarily obscure various embodiments of the present disclosure.

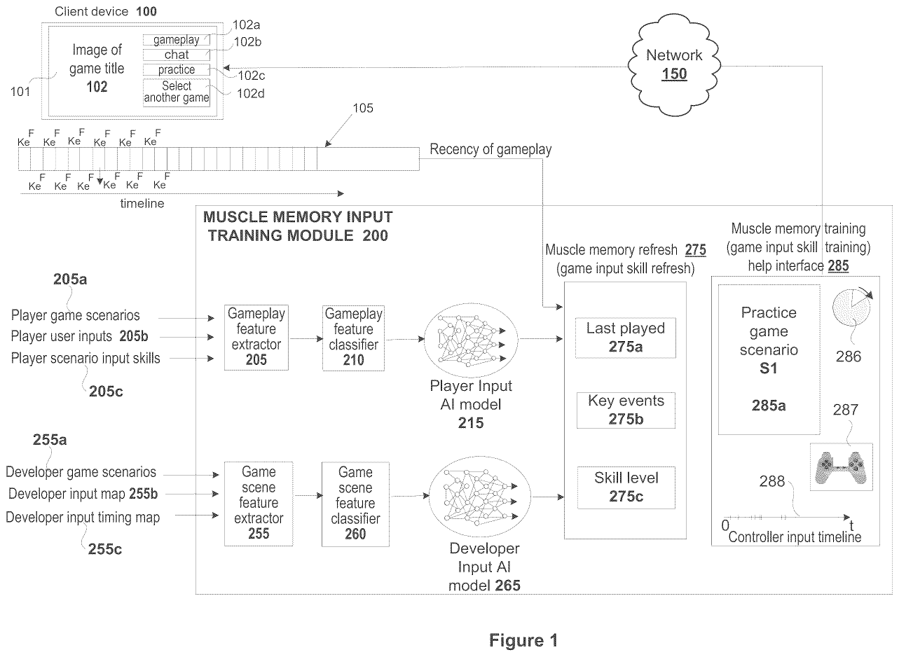

FIG. 1 illustrates a simplified block diagram of a system that is used to detect areas (i.e., portions) where a player can benefit by practicing their game inputs (i.e., improve their input skills) to progress in the video game and to provide one or more practice game scenarios that target the specific game inputs (e.g., type, sequence, combination, timing, etc.,) that the player needs to master, in some implementations. The practice game scenarios are generated to include key events or tasks or challenges that closely replicate the ones in the video game that the player needs to practice. The practice game scenarios are presented on a user interface 101, such as a help interface, for a player to select and practice prior to selecting the video game for gameplay. In addition to one or more practice game scenarios, the help interface also includes a timer to visually show to the player how the speed of game inputs provided by the player stacks up against the timing requirements specified for the key event(s) included in the practice game scenarios, and a visual representation of control inputs for demonstrating the game inputs required for the practice game scenario. Specifically, the visual representation of the control inputs is used to demonstrate to the player the sequence, combination, and/or rhythm of control inputs that needs to be activated and time between activation of the different control inputs for the practice game scenarios.

FIG. 1 shows an example of a user interface 101 presented on a client device 100 of a player for player selection, in one implementation. The user interface 101 can include an image of a game title of a video game 102 the player has selected or has expressed interest in gameplay along with some options for player selection. In an implementation illustrated in FIG. 1, some of the options provided with the image of the game title of the video game 102 includes a “gameplay” option 102a, a “chat” option 102b, a “practice” option 102c and “select another game” option 102d. The aforementioned options provided for player selection are mere examples and should not be considered exhaustive. When the player selects the gameplay option 102a, the user interface 101 is used by the player to provide game inputs using one or more input devices and, frames of game content generated by the game logic by applying the game inputs of the player. When the player selects the chat option 102b, the player can participate in a chat session with at least one user, wherein the user could be another player, a spectator or a developer. When the player selects the practice option 102c, a muscle memory input training (MMIT) module 200 is used to identify a portion of the video game that the player can benefit with additional training. The identified portion could be where the player left off (i.e., paused gameplay) during their prior gameplay session, or could be the portion with a key event that the player struggled to provide the inputs to progress. When the player selects “select another game” option 102d, the player can be presented with game titles of other video games that the player has previously played, spectated or has access.

When the muscle memory input training (MMIT) module receives the practice request from a player (i.e., selection of option 102c), the MMIT module 200 queries and receives a history of gameplay data 105, if any exist for the player, from prior gameplay session(s) of the player. The history of gameplay data 105 is stored in a gameplay datastore (not shown) and the MMIT module 200 queries and retrieves the history from the gameplay datastore for the player for the video game. The history of gameplay data 105 is represented in a timeline from which the frequency of gameplay of the player, number of gameplay sessions the player has engaged in for the video game over time, details of progress made by the player within the video game in each gameplay session, etc., can be easily determined. The details of progress made by the player in the video game includes details of gameplay, such as details of game scenarios 205a encountered and completed by the player, game inputs 205b provided by the player (also referred to as “user inputs”) in each of the game scenarios 205a, game content generated by applying the game inputs of the player, key events that were attempted in different portions of the video game, status of each key event in each game scenario attempted by the player, inputs provided during each attempt of the key event, number and type of the key events that were successfully accomplished, number of type of key events that were unsuccessful, time taken to complete each key event, etc. The game inputs provided by the player in each game scenario can be used to identify the various input features, such as type, sequence or combination of the game inputs, time aspect (slow or fast, synchronous or asynchronous) associated with the game inputs, etc. These features of the game inputs in each game scenario can be used to determine the input skills 205c achieved by the player during gameplay of each game scenario and for the video game as a whole. In addition to the input skills 205c, the details of game inputs of the player are also used to determine if the game inputs of the player meet the necessary timing requirement specified for the inputs in each game scenario of the video game.

A gameplay feature extractor 205 of the MMIT module 200 obtains the gameplay data of the player, analyzes the gameplay data to identify and extract the various features of game inputs provided by the player in different portions of the video game during different gameplay sessions and provide it to a gameplay feature classifier 210 as inputs. The gameplay feature classifier 210 classifies the various features identified from the game inputs of the player. In some implementations, the various features of game inputs are analyzed to identify game metrics that are categorized into different categories in accordance to certain standards defined for the input metrics in the video game, and the categorized input metrics are classified. For instance, the game inputs may be categorized in accordance to type of game inputs provided, attributes of key events (e.g., difficulty level, number of adversaries or challenges included, level of the video game, etc.,) for which the game inputs are provided, effect of the game inputs at the key event, etc. In other implementations, the game inputs can be categorized in accordance to different standards defined for the video game. The classification, in some implementations, is done by assigning a relative weight to each input metric that correlates with the various categories of features, such as ease/difficulty of providing certain inputs, types of moves (single vs. multiple tap/press, sequential vs. parallel inputs, synchronous vs. asynchronous, combination of inputs, etc.), time related input features, etc. The identified and classified features of game inputs of the player are provided as inputs to generate and train a Player input artificial intelligence (AI) model (simply referred to as “Player AI model”) 215. The outputs of the Player AI model 215 are used to determine the game skills acquired by the player and the game skills that the player needs to practice for succeeding in the video game. In addition to the game skills, the classified inputs are also used to provide feedback to the player, wherein the feedback provides details of the player's performance in each category of the input metrics identified for inputs provided in the practice game scenario.

The MMIT module 200 also queries game logic of the video game to obtain details of each game scenario 255a including details of key events defined within, input map 255b and input timing map 255c defined by a developer of the video game. A game scene feature extractor 255 uses the details provided by the game logic to identify and extract various developer defined features of each game scenario and provide the identified developer defined features as inputs to a game scene feature classifier 260. As with the player's gameplay feature classifier 210, the game scene feature classifier 260 categorizes and classifies the game scene features in accordance to a scale defined for the various game scene feature categories, such as difficulty level or complexity of key event(s) in each game scenario (e.g., number of enemies to vanquish, speed of attack from enemies, time requirement to accomplish the key events, speed required to provide the game inputs, etc.), difficulty level associated with the game inputs required to accomplish the key events in each game scenario, etc. The identified and classified developer defined game scene features are provided as inputs to generate and train a developer input AI model 265. The outputs of the developer input AI model 265 are used to identify the different key events that player will encounter in each game scenario, the difficulty level of the key events, the timing requirements for accomplishing the key events, etc., that the player can experience in each game scenario. The key events in the video game can relate to actions performed in the video game by a game character controlled by game logic of the video game or by inputs provided by another player, and the inputs provided by the player are in response to the actions performed by the game character, for example. The player AI model 215 and the developer input AI model can be generated and trained using machine learning algorithm, which includes logic to use the extracted features and classifiers associated with the player's inputs and developer defined inputs to determine how the player's inputs compare against what is defined by the developer and when the player may need assistance to assist them in tackling different key events and progress in the video game. In some cases, the machine learning algorithm can also use inputs provided by other players to determine how the player's input skills rank against the other players and the type and amount of assistance that can be provided to the player.

A muscle memory refresh module 275 of the MMIT module 200 uses the outputs of the player input AI model 215 and the developer input AI model 265 and compares the outputs for different game scenarios to determine if the player has the necessary input skills to accomplish the key event in each game scenario. The muscle memory refresh module 275 takes the input skills and the time the player took to provide the inputs in each game scenario and maps them to the developer input map 255b and developer input timing map 255c defined for the corresponding developer defined game scenario 255a of the video game. The developer input map 255b and the developer input timing map 255c defined for each developer defined game scenario 255a is indicative of which type, sequence or combination and speed at which the game inputs have to be provided to achieve the optimum result in each game scenario. The game inputs of the player and the time taken by the player to provide the game inputs are indicative of the game skills acquired by the player for the video game. The mapping is done to compare the input skills of the player against the developer defined inputs and input timings to determine if the player has the necessary input skills (i.e., muscle memory) and can accomplish the task or challenge within the timing requirement defined for the key event or can benefit from practicing providing the game inputs prior to (or during) gameplay of the video game.

In some cases, based on the mapping, the muscle memory refresh module 275 of the MMIT module 200 may determine that the player can benefit with additional practice for a specific key event and identify a game scenario that includes the specific key event for the player to practice. In some implementations, the MMIT module 200 may identify the game scenario associated with the last key event that the player unsuccessfully attempted or partially completed during their prior gameplay session. The MMIT module 200 uses the identified game scenario to generate a corresponding practice game scenario with at least a practice key event that replicates the key event included in the game scenario where the player left off or where the player can benefit from practicing. It should be noted that the practice key event included in the practice game scenario corresponds to the key event that the player has already played and is not related to any event that is scheduled to occur in subsequent portions of the video game that the player is yet to attempt or get exposed. This is to ensure that the practice session preserves an element of surprise for the player (i.e., prevent “spoiler alert” from occurring).

A muscle memory refresh module 275 of the MMIT module 200 analyzes the gameplay data from the history of gameplay (105) of the player to determine a player's need to practice game inputs to master certain input skills, and to identify and provide the one or more practice game scenarios for the player to gain the input skills. The history of gameplay data can be stored in a gameplay datastore (not shown) and queried by the muscle memory refresh module 275, when the player accesses the video game with the intention of engaging in gameplay. The gameplay data is a cumulation of the game inputs of the player and the game content generated for the video game by applying the game inputs received during the prior gameplay sessions. The gameplay data from the various gameplay sessions is used to determine the type, sequence, combination and timing of the various game inputs provided by the player in the different game scenarios, and also the timeline when the player selected the video game for gameplay. The temporal attributes associated with each gameplay session is used to determine the recency of gameplay of the player, which is used to determine how long since the player last played the video game. The passage of time since the player's last gameplay of the video game can be used to determine if the player has retained their muscle memory to provide appropriate game inputs for the video game or is experiencing muscle memory loss (i.e., forgotten some of the game inputs or sequence/combination of the game inputs, or the timing requirement). The passage of time can indicate that the player has been away from the video game for a defined period of time (e.g., 1 day, 1 week, 1 month, 1 year, etc.,). The passage of time since the last gameplay session is generally directly related to amount of potential muscle memory loss, with the increase in the passage of time leading to increase in muscle memory loss and vice versa. The muscle memory, as used in this application, relates to the ability of consistently reproducing a particular movement (e.g., key strokes on a typewriter, a particular combination of inputs using an input device, such as a controller, in the case of a video game) without thinking and such reproduction is due to repetition of that movement over time. As time passes since the player last reproduced the particular movement (i.e., particular combination of game inputs), the player can likely lose the muscle memory and may need to regain it before attempting the video game.

Based on the passage of time since the player last played the video game, the muscle memory refresh module 275 may be able to determine if the player needs to have some practice with certain ones of the game inputs and identify one or more game scenarios to allow the player to practice providing the game inputs to regain the muscle memory. The last played data 275a obtained from history of gameplay of the video game can be used to determine an appropriate key event 275b and the game scenario associated with the key event to provide to the player for practice. The key event identified may be the one that the player last attempted or played in a previous gameplay session, in which case, the game scenario associated with the last key event may be provided to the player to help the player regain their muscle memory that may have been lost due to passage of time.

In another example, if the recency of gameplay obtained from the history of prior gameplay sessions of the player indicates that the passage of time between a current gameplay session and a prior gameplay session is not long for the player to experience muscle memory loss (i.e., the passage of time may be a day or two), the muscle memory refresh module 275 may use the last played data 275a obtained from the history of gameplay of the player to determine a specific key event that the player consistently had difficulty in accomplishing in the previous gameplay session or in a number of prior gameplay sessions, and the associated game scenario for providing as an option for the player to practice to regain their muscle memory.

In addition to using the history to identify specific portions of the video game that the player can benefit from practicing, the MMIT module 200, in some implementations, can detect a unique combination of inputs provided by the player to overcome a very challenging task during gameplay. The player may not even be aware that they were capable of providing such combination and/or that the combination would result in such outcome. The player may want to know what the combination was so that they can practice those inputs for use when they encounter the key event in a subsequent portion or during subsequent gameplay of the video game. Options identifying a key event or the outcome of the key event in a portion of the video game where the unique combination of game inputs were provided by the player may be provided on the user interface (e.g., help interface) for player selection. In response to the player selecting the option, the MMIT module 200 can identify the portion of the video game in which the unique combination was provided by the player, generate a practice game session replicating the key event that required the unique combination, and provide the practice game scenario for the player. The practice game scenario can also include a visual demonstration of the unique combination of inputs using a input device, such as a controller, so that the player can practice and get familiarized with the input combination.

In some implementations, instead of the muscle memory refresh module 275 tracking the input skills of the player and the recency of gameplay of the player to identify and provide the practice game scenario to the player to improve their input skills, the muscle memory refresh module 275 may receive explicit request from the player expressing interest in practicing game inputs to refresh their muscle memory prior to actually playing the video game. In such implementations, a user interface 101 on which the video game title is presented for player selection can also include options to allow the player to specify the key event in the video game where the player would like more practice prior to playing the video game. In some other implementations, the one or more key events that the player had already attempted in the video game are identified and presented to the player with an option to select any one of the presented key events. Depending on the player specification (or selection), the MMIT module 200 may identify a portion of the video game that includes the key event specified by the player, generate a practice game scenario with a practice key event that replicates the specified key event and present the practice game scenario on the user interface 101 for player to select and practice.

In some implementations, in addition to relying on the history of gameplay of the player or the player's expressed interest to determine if the player needs to refresh their muscle memory, the muscle memory refresh module 275 may track the player's progress in a current gameplay session to determine if the player needs some practice to refresh or improve their muscle memory to accomplish the tasks or challenges associated with a key event of the video game. When the muscle memory refresh module 275 detects the player struggling in a game scenario of the video game that the player is currently engaged in, the muscle memory refresh module 275 dynamically generates a practice game scenario by inheriting all attributes of the one or more key events in the game scenario of the video game and provides the practice game scenario in a help interface with information related to inputs required for completing the one or more key events. In some implementations, the practice game scenario is provided to the player by pausing the gameplay of the player in the current gameplay session to allow the player to practice their game skills (also referred to as “input skills” or “game input skills”) and once the player has achieved the game skills required for the game scenario, resuming the current gameplay session.

The information related to the inputs provided with the practice game scenario, in some cases, includes a visual of the input device to demonstrate the control inputs that need to be pressed or activated and the time interval between each control input or combination of control inputs. The input information with details of the game scenario with the key event for replicating and providing to the player to practice can be obtained using details of the developer game scenarios 255a defined for the video game, the specific ones of control inputs to press from developer input map 255b and the time requirement (i.e., time between different inputs, total time to complete the key event) from developer input timing map 255c defined by a developer of the video game. In some implementations, the input device used to provide the visual of the control inputs corresponds with the input device used by the player to provide the inputs.

In some implementations, the practice game scenario provided to the player can include a level of complexity that corresponds with the level of complexity of the actual game scenario that as used to replicate the practice game scenario. In alternate implementations, the practice game scenario can be defined with a level of complexity that is lower than the level of complexity of the actual game scenario, wherein the amount to which the level of complexity is reduced may depend on the severity of the muscle memory loss experienced by the player. As previously noted, in some cases, the muscle memory loss can depend on the passage of time since the player last played the game. Alternately, the muscle memory loss may depend on other factors, such as injury sustained by the player that prevents the player from providing the inputs, for example. As the player practices game inputs using the practice game scenario and improves their input skills, the complexity of the practice game scenario can be iteratively increased till the level of complexity of the practice game scenario matches or exceeds the level of complexity of the actual game scenario used for generating the practice game scenario.

In some implementations, the practice game scenario may be generated by adjusting one or more gameplay metrics, such as speed at which the practice game scenario progresses, timing requirement for providing the inputs for completing the key event, etc. In some implementations, the practice game scenario is defined by adjusting an event timing requirement of a key event when replicating the key event in a practice game scenario. For example, the event timing requirement of the replicated key event in the practice game scenario is adjusted based on input skills of the player. If the input skills of the player indicate total muscle memory loss, then the timing requirement for the replicated key event in the practice game scenario is adjusted to be generous in that the player is provided a lot of time to complete the key event in the practice game scenario. On the other hand, if the input skills of the player indicate that the player has a decent amount of muscle memory and needs little practice to improve their muscle memory, the timing requirement may be defined to be more stringent. In either case, the timing requirement of the practice game scenario is iteratively adjusted for subsequent gameplay and such iterative adjustment is done by the MMIT module 200 after detecting the player has mastered the input skills and meets the timing requirement defined for the initial practice game scenario. In some implementations, the timing requirement is iteratively adjusted by a predefined percent after detecting the player's master of inputs. In other implementations, the iterative adjustment to the timing requirement is defined based on how quickly the player developed the input skills for the initial practice game scenario. In some implementations, the number of iterations to the timing requirement (or any other gameplay metric) is driven by the desire of the player to master the game inputs, the amount of input skills acquired by the player, the percent of iterative adjustment made, etc. In some implementations, the iterative adjustments are made to the timing requirement so long as the player expresses interest in practicing using the practice game scenario and till the timing requirement required to complete the replicated key event in the practice game scenario matches or exceeds the timing requirement of the key event in the actual game scenario. Although the various implementations were described to iteratively adjust the timing requirement metric, it is to be noted that the implementations are not restricted to the timing requirement adjustment but can be easily extended to iteratively adjusting other gameplay metrics, such as speed of gameplay, complexity of gameplay, type and number of inputs to present, etc.

In some implementations, the practice game scenario for a key event is defined to include a plurality of gameplay metrics and is provided to allow the player to practice for a defined number of times or for as many times as they want to improve and/or refresh their input skills (i.e., build or maintain muscle memory). In some implementations, the practice game scenario is defined with an initial value for the gameplay metrics (e.g., timing requirement, speed, complexity, etc.) that define an initial input requirement, wherein the initial value for the gameplay metrics may depend on the passage of time since the player last played the video game, the input skills (i.e., muscle memory) exhibited by the player, and/or the complexity of input skills required to complete the key event. As the player practices and masters the inputs skills that meet or exceed the initial input requirements and based on the complexity of the key event, a second practice game scenario may be provided with adjustment to one or more gameplay metrics. The process of iterative adjustment to the one or more gameplay metrics of the practice game scenario for subsequent gameplay may continue till the player acquires the input skills required to complete the key event in the game scenario of the video game.

In some implementations, the player is allowed to play the practice game scenario for a defined number of times. After expiration of the defined number of times, the player is provided with the option to resume gameplay of the video game. In some implementations, the defined number of times the player is allowed to play the practice game may be set dynamically based on the input skills (also referred to as “game skills”) of the player, the performance of the player in the practice game scenario, and game skills required to complete the replicated key event, to name a few.

In some implementations, the practice game scenario is designed to build up on the input skills of the player. When the key event is a complex one requiring complex game inputs, the complex game inputs can be broken down into multiple sub-sets and a plurality of secondary practice game scenarios are generated, wherein each secondary practice game scenario is designed by identifying and replicating a distinct key event that enables the player to master the skills defined in each sub-set. As the player masters the input skills of each sub-set, additional secondary practice game scenarios are generated to include one or more key events that require the combination of inputs in the two or more sub-sets, to enable the player to slowly build up their input skills.

To assist the player in practicing inputs for each sub-set, each sub-set is customized to have its own secondary practice game scenario with its own timer and timeline to encourage the player to focus on improving incrementally. In some implementations, where the secondary practice game scenario includes more than one key event, each key event in such secondary practice game scenario can have its own timer and timeline to enable tracking inputs for the key event and for the secondary practice game scenario. Each of these secondary practice game scenarios are customized based on the player's input skills to further encourage the player to attempt mastering the game inputs, incrementally. This may especially be useful to the player as they attempt to master the complex inputs required for certain key events as each sub-set of inputs is designed to build up on the player's existing input skills and, consequently, their confidence level in tackling the complex key events.

In some implementations, recognizing the player's current input skills, the practice game scenario is generated to include a replicated key event identified for the player's practice with the timing attribute being adjusted to be very generous. The generous timing requirement can be defined based on a number of factors, such as the player's input skills, the complexity of the game inputs required to complete the key event, the recency of gameplay of the player, etc. As the player master's the input skills required for the key event within the practice game scenario and meets the generous timing requirement, the timing requirement for the practice game scenario is iteratively adjusted to increase in strictness for a subsequent gameplay by the player. As the player continues to improve their input skills and meet the stricter timing requirement, the timing requirement for the practice game scenario can be further adjusted till the timing requirement for the practice game scenario matches or exceeds the timing requirement defined for the key event by the developer of the video game. In some implementations, the increase in strictness of the timing requirement, for example, can be defined by the player. For example, the player may indicate that they would like the practice game scenario to have a timing requirement that is stricter than what is defined for the actual game scenario so that the player will be able to complete the key event with ease, during gameplay of the video game. Of course, the timing requirement is one of the attributes that can be adjusted for the practice game scenario and other attributes, such as speed, complexity, etc., can also be similarly adjusted.

The practice game scenario 285a with the defined set of attributes are packaged with information to assist the player during practice to complete the key event contained within and forwarded on a user interface, such as a help interface, 101 over a network 150 to a client device 100 of the player for rendering on the display screen of the client device 100. The information that is included with the practice game scenario 285a, in some implementations, include tools to assist the player and monitor the player's progress. Some of the tools can include a timer 286, such as a countdown timer, to keep track of the timing of the inputs provided by the player, an image of a controller 287 to demonstrate the control inputs that are needed to complete the key event, and a timeline 288 showing the time when different inputs need to be provided. The timer 286 may be provided to create a sense of urgency and to mimic the timing constraints of the actual game scenarios. The timeline 288 provides guidance to the player on the overall timing for all inputs needed in the practice game scenario by instructing the player on the rhythm of inputs (e.g., button presses on an input device or activation of control inputs on a controller), the intervals between the inputs, and the precise sequence or combination required to successfully navigate the given scenario. The practice game scenario serves as targeted training exercise to improve the player's input skills in handling challenging sequences, thereby providing the player with the required playing skills and confidence in tackling the actual game scenarios of the video game. The practice game scenarios are provided with an aim to instill muscle memory in the player by allowing the player to repetitively execute the correct input combinations and to help the player understand the correct way to press buttons for fluid and precise control during actual gameplay. The aforementioned tools are provided as mere examples and fewer or additional tools may also be provided at the user interface. The various tools are provided to let the player improve their input skills and gain confidence so as to keep the player engaged longer in the video game.

Once the player is presented with the practice game scenario, the gameplay of the practice game scenario is monitored by the muscle memory refresh module 275 to determine how the player progresses in the practice game scenario. Based on the player's performance, the muscle memory refresh module 275 adjusts the difficulty level of the practice game scenario. For example, if the player consistently succeeds, the difficulty level of the practice game scenario may be increased to let the player improve their performance and maintain player engagement. If, however, the player repeatedly fails, the muscle memory refresh module 275 to reduce the difficulty level and/or provide additional assistance, such as breaking the inputs into sub-inputs and providing multiple secondary practice game scenarios targeting the sub-inputs for the player to master, or modify the practice game scenario to better match the player's skill level.

In addition to providing assistance to the player based on the player's performance, the muscle memory refresh module 275 provides feedback on the player's performance. The feedback can be provided after end of each gameplay of the practice game scenario or in real-time to assist the player to provide correct inputs. The feedback after end of each gameplay, for example, can include metrics, such as accuracy of inputs provided, completion time, adherence to timing requirements, etc. In addition, the feedback can also identify certain types or combination of inputs that the player provided, and to provide an option to improve those types or combination of inputs. The option to improve may include a first option to continue to practice with the practice game scenario and a second option to practice an alternate practice game scenario. The alternate practice game scenario is generated and provided based on the progress made by the player in the practice game scenario and the input skills still required to be mastered. The feedback is generated to provide the player with a constructive guide for improvement, thereby assisting the player in not only overcoming input-related or control-related challenges but also ensuring a holistic and engaging learning experience that contributes to overall skill enhancement and enjoyment of the game.

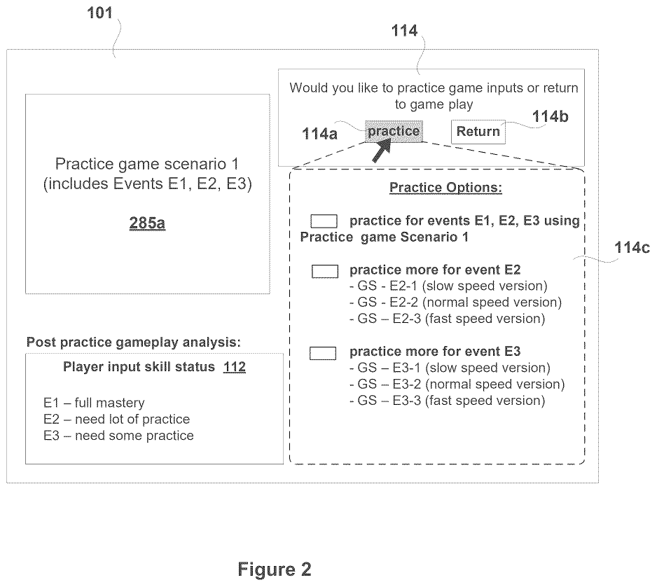

FIG. 2 illustrates a sample user interface 101 used for presenting practice game scenario for the player to practice and feedback related to the performance of the practice game scenario and additional options to select specific portion of the practice game scenario that the player wants to practice more, in one implementation. The user interface 101 includes a first section to receive the inputs from the player and to provide the game content of the practice game scenario 285a, a second section 112 to provide practice gameplay analysis, and a third section 114 to provide options for the player to continue playing the practice game scenario or to resume gameplay of the video game. The practice gameplay analysis is provided after conclusion of the gameplay of the practice game scenario and can include feedback such as the key event(s) included in the practice game scenario and the player's skill status when attempting the key event(s). In the example provided in FIG. 2, the practice game scenario 1 includes 3 key events (E1, E2 and E3) and the practice gameplay analysis provided in the second section 112 shows the player's status in each of the 3 key events. For example, the MMIT module 200 tracks the gameplay of the player in the practice game scenario and determines, based on the player's inputs, that the player has full mastery of inputs required to complete key event E1 (i.e., consistently able to provide the required inputs), needs a lot of practice to complete key event E2, and needs some practice (i.e., has some mastery but could benefit with additional practice) to complete key event E3. The above feedback to the player is provided as a mere example and additional feedback may be provided to the player.

In addition to the gameplay analysis, the user interface 101 could also provide options, such as a first option 114a to continue practicing gameplay of the practice game scenario and a second option 114b to resume gameplay of the video game. When the player selects the first option 114a, the MMIT module 200 can use the practice gameplay analysis and provide additional sub-options in the third portion 114c of the user interface (i.e., help interface) 101. For example, the additional sub-options may include a first sub-option to continue to practice the practice game scenario to master the inputs for all 3 key events (E1,E2, E3), a second sub-option to practice inputs for key event E2 and a third sub-option to practice inputs for key event E3. In some implementations, when the player selects the second sub-option, for example, the MMIT module 200 may identify a game scenario of the video game where the key event E2 is present and generate a second practice game scenario replicating the key event E2 and present it for player selection to practice. In some implementations, multiple versions of the second practice game scenario may be generated, wherein each version of the second practice game scenario may be generated by adjusting one or more game metrics associated with the key event E2. In the example shown in FIG. 2, three versions of the second practice game scenario with the key event E2 are generated by adjusting the speed of the gameplay, wherein a first version of the practice game scenario for key event E2 (GS-E2-1) is generated to progress at a slow speed, a second version (GS-E2-2) is generated at normal speed and a third version (GS-E2-3) is generated at fast speed, wherein the slow, normal and fast speed are defined based on the speed at which the key event E2 is being rendered in the actual game scenario of the video game.

Similarly, for practicing inputs for key event E3, a third practice game scenario replicating the key event E3 is generated and as with key event E2, multiple versions of the third practice game scenario can be generated by adjusting the speed metric-e.g., GS-E3-1 generated to render at slow speed, GS-E3-2 generated to render at normal speed, and GS-E3-3 generated to render at fast speed, wherein the speed of rendering in each version is defined based on the speed of the key event E3 in the actual game scenario. In some implementations, each of the sub-options for practicing the different key events are presented as check-boxes for player selection. Other ways of selecting the different sub-options, such as radio-buttons, selectable hyperlinks, etc., can also be envisioned. Based on the player's selection, the player is presented with the appropriate option/sub-option for further practice.

When the player selects the second option 114b, the MMIT module 200 can present the player with the video game for gameplay. The MMIT module 200 determines the point (i.e., a resumption point) where the player left off in the previous gameplay session and presents the video game for gameplay by the player starting at the resumption point.

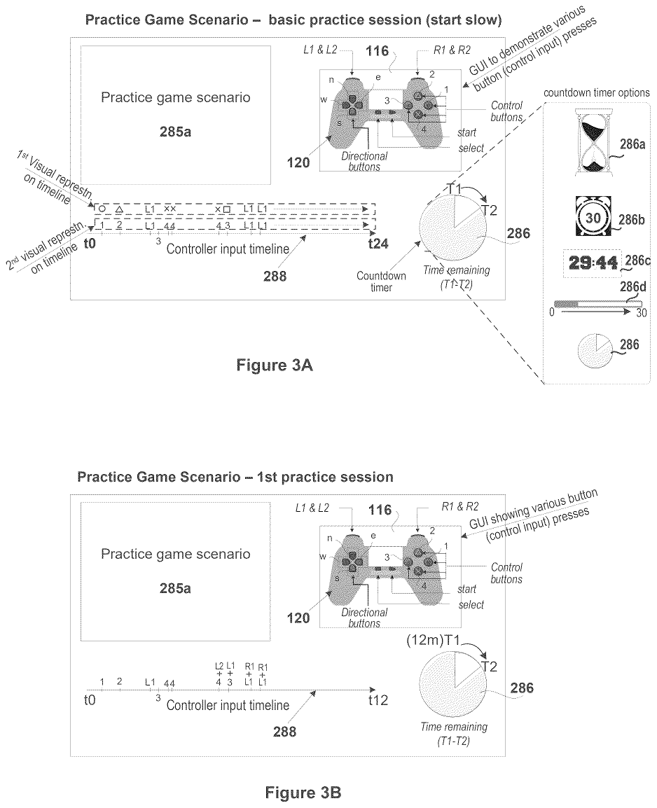

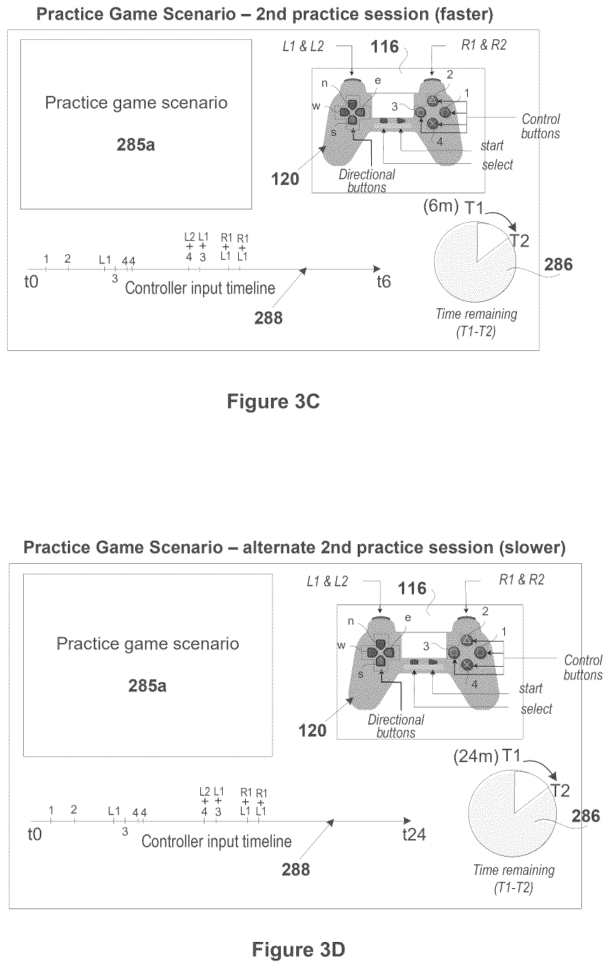

FIGS. 3A-3D illustrate user interfaces showing the practice game scenario and informational tools related to the practice game scenario that are provided to the player, in some implementations. The user interface (also referred to as help interface as it helps the player to practice providing game inputs) 101 includes the first portion to provide the content of the practice game scenario 285a that is updated using practice game inputs provided by the player. FIG. 3A shows additional informational tools provided at the user interface to assist the player during practice of the practice game scenario than what was shown in FIG. 2. For example, the user interface includes a visual representation (i.e., an image) of a controller (i.e., an input device) 120 in a second portion 116. The image of the controller 120 shows the different control inputs available for providing the inputs. The input device is not restricted to a controller 120 but can include other input devices, such as touch-screens, keys (e.g., arrow keys) on a keyboard, etc. The additional informational tools include a countdown timer 286 in the form of a pie-shaped timer, wherein ‘T1’ represents the timing requirement that the player has to meet for the practice game scenario and ‘T2’ represents the amount of time that has passed since the player started playing the practice game scenario. The MMIT module 200 can use the values of T1 and T2 to arrive at the time remaining as the difference between T1 and T2. The count-down timer 286 is not restricted to the pie shaped timer but can be represented in other forms, such as an hour glass 286a, a count-down clock timer 286b, a digital timer 286c, a progress bar 286d, a sliding line, a bar graph, to name a few. The user interface 101 also includes a controller input timeline 288 to show the different inputs that need to be provided and the passage of time between each input. The input for the practice game scenario can include single vs. multiple tap/button presses, sequential vs. parallel inputs, synchronous vs. asynchronous inputs, etc., and the controller input timeline 288 can provide a visual representation of the different inputs. some implementations where the controller 120 is being used as an input device, the input controls can be represented numerically or using symbols of the input controls, such as triangle, square, circle, ‘X’ and/or direction arrows. The controller input timeline 288 can show the different inputs that need to be provided at different times of gameplay using the numbers or symbols of the respective input controls of the controller 120. FIG. 3A shows a first visual representation of the control inputs required at different times of the practice game scenario along the timeline using the symbols of the input controls, and the second visual representation of the control inputs along the timeline using numerical representation. In some implementations, the visual representation of the control inputs can be provided to the player as the player is playing the practice game scenario so that the player can follow the lead and practice the inputs. In these implementations, the feedback can be provided to the player in substantial real-time so that the player can correct the inputs. In some other implementations, the timeline with the different control inputs can be generated and presented at the user interface 101 prior to the player accessing the practice game scenario for practice and as the player progresses in the practice game scenario, the portion of the timeline corresponding to the location of the player in the practice game scenario can be highlighted to indicate to the player how far they are in the practice game scenario.

FIG. 3B illustrates a user interface for rendering the game content of the practice game scenario for practicing by the player. The timing requirement is provided along the timeline 288 and the countdown timer is represented using a pie-shaped timer (286). The timeline shows the timing requirement to be 12 minutes (shown at the end of the timeline 288 and beside ‘T1’ in the pie-shaped timer (286)) to complete the practice game scenario along with the control inputs that need to be provided at different times using the corresponding numerical values. In some implementations, more than one control input may be required at a given time (e.g., (L2 button+control input corresponding to numerical value 4 on the controller 120) or (R1+L1)). The timeline 288 shows the control input pattern that need to be followed (e.g., sequential vs. parallel) while the controller 120 is used to visually demonstrate the control inputs by activating the appropriate input controls.

FIGS. 3C and 3D illustrate follow-up practice game scenarios with the timing attribute of the practice game scenario adjusted, based on the skill level of the player, in some implementations. When the player consistently exceeds providing the inputs within the timing requirement defined for the practice game scenario, the timing requirement of the subsequent practice game scenario presented to the player at the user interface is adjusted to be faster (i.e., a stricter timing requirement defined) than the initial practice game scenario illustrated in FIG. 3B. In the example shown in FIG. 3C, the timing requirement of the subsequent practice game scenario is adjusted to be 6 minutes (i.e., stricter timing requirement) than the 12 minutes defined in FIG. 3B. The timeline 288 in FIG. 3C reflects the stricter timing requirement at the end of the timeline and the countdown timer 286 counts down from 6 minutes (shown next to ‘T1’ in the pie-shaped timer (286)) instead of 12 minutes shown in FIG. 3B. Alternately, the player may consistently fail to provide the inputs within the timing requirement defined for the practice game scenario and, as a result, the timing requirement of the subsequent practice game scenario presented to the player at the user interface is adjusted to be slower (i.e., a liberal or generous timing requirement defined) than the initial practice game scenario illustrated in FIG. 3B. Accordingly, the timeline 288 reflects the extended timing requirement of 24 minutes at the end of the timeline 288 and the countdown timer 286 is adjusted to countdown from 24 minutes, as shown beside ‘T1’. Although the implementations illustrated in FIGS. 3B-3D show the timing metric being adjusted, it should be noted that other metrics, such as speed, input complexity, etc., can also be adjusted to suit the practice requirements of the player.

The various implementations described herein provide a mechanism to assist a player to remember or recall or regain the controller inputs from the last time they played the video game and improve their muscle memory for subsequent gameplay of the video game. The practice game scenarios are customized to the needs of the player based on the input complexity of the key events, the input requirements of the key event contained within, and the input skills possessed by the player so that the player is not overwhelmed or discouraged by the challenges of completing the key event. Feedback (e.g., in graphical format, textual format, etc.,) is provided to inform the player of the progress they have made in the practice game scenario and include details related to where they stand in meeting the input skills and the timing requirements defined for a key event included in each practice game scenario provided to the player. In some implementations, the feedback can be provided in different formats, including audio format, textual format, haptic format, visual format, or any combinations thereof. In some implementations, the feedback in the graphical format can be provided for each metric identified from the player's inputs so as to provide a visual representation of the progress made by the player for each input metric and to show how the player is able to meet the input and timing requirements and where the player needs additional assistance in the practice game scenario. In some implementations, the feedback provided to the player can also include details on how their input skills for the key event in each practice game scenario compare against other players' input skills. The details for such feedback are obtained by comparing the performance of the player with that of the other players. The customization of the game scenario for the player and the timely feedback are provided to encourage the player to improve their input skills and to keep the player engaged, which can result in increased interest in the video game.

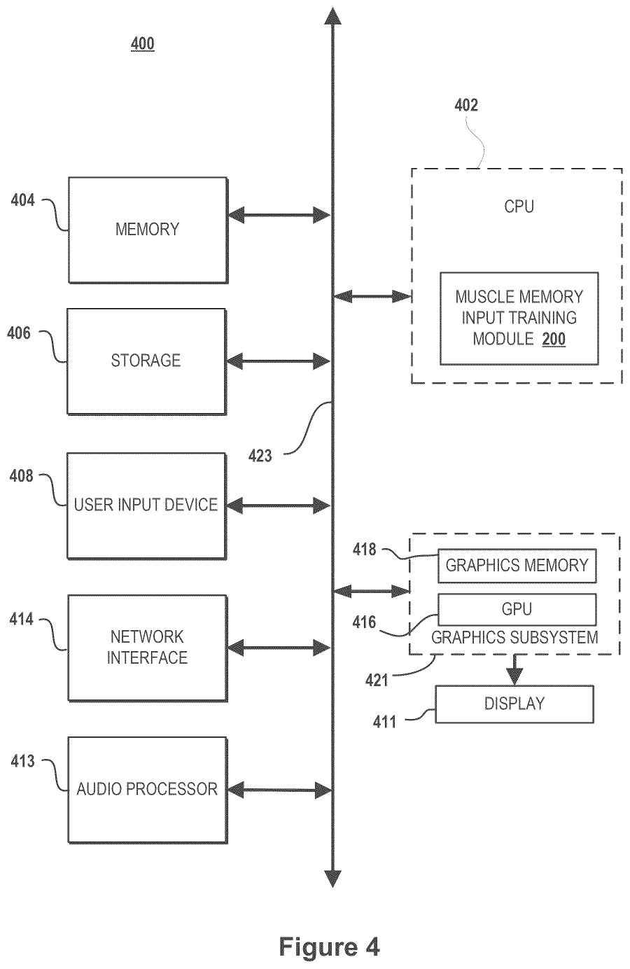

FIG. 4 illustrates components of an example system (e.g., server device within cloud game network of FIG. 1) that can be used to perform aspects of the various embodiments of the present disclosure. This block diagram illustrates a device 400 that can incorporate or can be a personal computer, video game console, personal digital assistant, a server or other digital device, suitable for practicing an embodiment of the disclosure. Device 400 includes a central processing unit (CPU) 402 for running software applications and optionally an operating system. In some implementations, the CPU 402 can include a muscle memory input training module 200 with instructions to assist a player by determining if the player can benefit from practicing inputs for one or more game scenarios and generating appropriate practice game scenarios with informational tools to assist the player in providing the inputs, monitor the inputs of the player and provide feedback on the status of the inputs provided and progress made in each of the practice game scenarios. CPU 402 may be comprised of one or more homogeneous or heterogeneous processing cores. For example, CPU 402 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. Device 400 may be localized to a player playing a game segment (e.g., game console), or remote from the player (e.g., back-end server processor), or one of many servers using virtualization in a game cloud system for remote streaming of gameplay to clients.

Memory 404 stores applications and data for use by the CPU 402. Storage 406 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 408 communicate user inputs from one or more users to device 400, examples of which may include keyboards, mice, joysticks, touch pads, touch screens, still or video recorders/cameras, tracking devices for recognizing gestures, and/or microphones. Network interface 414 allows device 400 to communicate with other computer systems via an electronic communications network, and may include wired or wireless communication over local area networks and wide area networks such as the internet. An audio processor 413 is adapted to generate analog or digital audio output from instructions and/or data provided by the CPU 402, memory 404, and/or storage 406. The components of device 400, including CPU 402, memory 404, (data) storage 406, user input devices 408, network interface 414, and audio processor 413 are connected via one or more data buses 422.

A graphics subsystem 421 is further connected with data bus 422 and the components of the device 400. The graphics subsystem 421 includes a graphics processing unit (GPU) 416 and graphics memory 418. Graphics memory 418 includes a display memory (e.g., a frame buffer) used for storing pixel data for each pixel of an output image. Graphics memory 418 can be integrated in the same device as GPU 416, connected as a separate device with GPU 416, and/or implemented within memory 404. Pixel data can be provided to graphics memory 418 directly from the CPU 402. Alternatively, CPU 402 provides the GPU 416 with data and/or instructions defining the desired output images, from which the GPU 416 generates the pixel data of one or more output images. The data and/or instructions defining the desired output images can be stored in memory 404 and/or graphics memory 418. In an embodiment, the GPU 416 includes 3D rendering capabilities for generating pixel data for output images from instructions and data defining the geometry, lighting, shading, texturing, motion, and/or camera parameters for a scene. The GPU 416 can further include one or more programmable execution units capable of executing shader programs.

The graphics subsystem 421 periodically outputs pixel data for an image from graphics memory 418 to be displayed on display device 411 (e.g., display device 111 of FIG. 2). Display device 411 can be any device capable of displaying visual information in response to a signal from the device 400, including CRT, LCD, plasma, and OLED displays. Device 400 can provide the display device 411 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (SaaS). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a graphics processing unit (GPU) since it will be doing a large number of relatively simple mathematical operations (e.g., matrix transformations). Other game engine segments that require fewer but more complex operations may be provisioned with a processing entity associated with one or more higher power central processing units (CPUs).

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and I/O. The client device can be a PC, a mobile phone, a netbook, a PDA, etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In one embodiment, the various technical examples can be implemented using a virtual environment via a head-mounted display (HMD). An HMD may also be referred to as a virtual reality (VR) headset. As used herein, the term “virtual reality” (VR) generally refers to user interaction with a virtual space/environment that involves viewing the virtual space through an HMD (or VR headset) in a manner that is responsive in real-time to the movements of the HMD (as controlled by the user) to provide the sensation to the user of being in the virtual space or metaverse. For example, the user may see a three-dimensional (3D) view of the virtual space when facing in a given direction, and when the user turns to a side and thereby turns the HMD likewise, then the view to that side in the virtual space is rendered on the HMD. An HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction. During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator. In either case, if the video game is represented as a simulation, that simulation is capable of being executed to render interactive content that can be interactively streamed, executed, and/or controlled by user input.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A method to allow a player to practice providing inputs to a video game, comprising:
analyzing gameplay of the player from one or more prior gameplay sessions of the video game to identify a portion of the gameplay where the player needs the practice to provide the inputs for a key event contained within;
generating a practice game scenario designed to replicate the key event that the player can practice to provide the inputs, the practice game scenario specifying a timing requirement for completing the key event; and
providing the practice game scenario on a help interface returned to a client device of the player for rendering on a screen of the client device used to interact with the video game, the help interface used to render content of the practice game scenario, a visual representation of control inputs used to provide the inputs required to progress in the key event included within, and a timer to track the inputs provided by the player meets the timing requirement specified for the key event within the practice game scenario,
wherein operations of the method are performed by a muscle memory input training module executing on a server computing device.

2. The method of claim 1, wherein the timing requirement for the practice game scenario is defined in accordance to an event timing requirement defined for the key event in the video game.

3. The method of claim 2, wherein the practice game scenario is defined to be played a plurality of times, wherein the timing requirement for an initial practice game scenario is defined to be longer than the event timing requirement defined for the key event in the video game, and for the practice game scenario played during a subsequent time by the player, the event timing requirement is decreased till the timing requirement matches or is less than the event timing requirement for the key event defined in the video game.

4. The method of claim 3, wherein the timing requirement is increased by a predefined percent for said each subsequent time, upon detecting the player has mastered the inputs within the timing requirement defined for a prior practice game scenario.

5. The method of claim 2, wherein the timing requirement for the practice game scenario is defined to be a shorter interval than the event timing requirement defined in the video game, the shorter interval defined to ensure the player is able to meet the timing requirement of the key event when providing the inputs in the video game, and
wherein upon detecting the player mastering the inputs for the key event, providing the player with option to resume the gameplay of the video game.

6. The method of claim 1, wherein generating the practice game scenario includes,
determining recency of gameplay of the video game by the player, the recency determined by computing an amount of time that has elapsed between prior gameplay session and a current gameplay session of the player;
determining a resumption point from where the player wants to resume the gameplay of the video game during the current gameplay session; and
generating the practice game scenario in accordance to the recency of the gameplay, the resumption point, one or more key events included in the video game prior to the resumption point, and game skill of the player.

7. The method of claim 1, wherein the practice game scenario is provided as a targeted training exercise for the player to practice providing the inputs for a defined number of times,
wherein, for each subsequent practice, one or more metrics of the practice game scenario is dynamically adjusted, based on performance of the player in a prior practice game scenario, and
wherein the defined number of times is specified by the player or defined by the muscle memory input training module based on the performance of the player in the prior practice game scenario, game skill required to complete the key event and game skill achieved by the player in said prior practice game scenario.

8. The method of claim 1, wherein a practice key event included in the practice game scenario generated for the player is selected to replicate the key event previously attempted by the player in the video game.

9. The method of claim 1, further includes providing feedback to the player on the progress in the practice game scenario, wherein the feedback provides details related to the inputs provided and meeting the timing requirement,
wherein the feedback is provided in one of audio format, textual format, haptic format, visual format, or any combinations of two or more thereof.

10. The method of claim 1, wherein generating the practice game scenario for the player further includes,
determining a complexity of the inputs required for completing the key event;
identifying game skills acquired by the player by analyzing inputs from the one or more prior gameplay sessions, wherein the game skills identify details related to consistency of a type, a sequence and a speed of the inputs provided by the player in the one or more prior gameplay sessions; and
designing a subsequent practice game scenario by adjusting complexity of the inputs required for completing the key event, the complexity of the inputs adjusted to build up on the game skills of the player.

11. The method of claim 10, wherein designing the practice game scenario further includes,
generating multiple secondary practice game scenarios, wherein each secondary practice game scenario of the multiple secondary practice game scenarios includes a distinct key event and is designed to iteratively increase the complexity of the inputs required to complete the distinct key event to build up the game skills of the player, and
wherein iteratively increasing the complexity includes at least one of increasing a speed of gameplay, reducing timing requirement for completing the distinct key event, and increasing an input speed of providing the inputs required for completing the distinct key event included within said each secondary practice game scenario.

12. The method of claim 1, further includes dynamically adjusting complexity of the inputs required to complete the key event for subsequent gameplay, based on performance of the player in the practice game scenario.

13. The method of claim 1, wherein rendering the visual representation of the control inputs on the help interface further includes,
presenting an image of a controller used for providing the control inputs available for the video game, the presenting includes demonstrating activation of specific ones of the control inputs to complete the key event, the visual representation providing guidance on sequence and timing of the control inputs for the player to practice, and
wherein the control inputs needed to complete the key event includes any one of sequential inputs, parallel inputs, and a combination of sequential and parallel inputs, and the visual representation shows the control inputs needed for completing the key event.

14. The method of claim 1, wherein the timer to track the inputs includes a count-down timer to keep track of time left to meet the timing requirement for completing the key event, the count-down timer provided as anyone of a progress bar, a pie chart, a count-down clock, a digital timer, a bar graph, or any combination thereof.

15. A method, comprising:
monitoring inputs provided by a player for a key event included in a portion of a video game selected for gameplay by the player in a current gameplay session;
detecting the player struggling to provide specific control inputs to complete the key event in the current gameplay session;
generating a help interface having information about the specific control inputs required to complete the key event; and
providing a practice game scenario for the player to practice providing the specific control inputs, wherein the practice game scenario is designed to replicate the portion of the video game where the player is struggling, the practice game scenario provided to assist the player to practice in providing the specific control inputs required to complete the key event.

16. The method of claim 15, wherein providing the practice game scenario includes inheriting attributes of a game scenario of the video game in which the key event is occurring, and the help interface provides a visual representation of the specific control inputs required to complete the key event.

17. The method of claim 15, wherein the practice game scenario includes a plurality of secondary practice game scenarios, wherein each subsequent secondary practice game scenario of the plurality of secondary practice game scenarios is designed to iteratively increase in complexity of inputs from a previous secondary practice game scenario, so as to allow the player to gradually improve providing the specific control inputs for completing the key event.

18. The method of claim 15, wherein the practice game scenario includes a plurality of secondary practice game scenarios, wherein each secondary practice game scenario of the plurality of secondary practice game scenarios includes a distinct key event that requires a subset of the specific control inputs to complete, and the help interface provides a visual representation of the subset of the specific control inputs used to build up input skills of the player required to complete the key event.

19. The method of claim 15, further includes,
generating additional practice game scenarios for the player for follow-up practice providing the inputs following the practice game scenario, each of the additional practice game scenarios generated by adjusting an input complexity for the portion of the video game included within;
monitoring performance of the player in the practice game scenario; and
dynamically presenting a second practice game scenario that is one of the additional practice game scenarios generated for the player for the follow-up practice, the second practice game scenario identified based on the performance of the player in the practice game scenario,
wherein the second practice game scenario presented to the player is of increased input complexity upon detecting the player consistently succeeding to provide certain ones of the specific control inputs required to complete the key event included in the practice game scenario, and
wherein the second practice game scenario presented to the player is of decreased input complexity upon detecting the player consistently struggling to provide the certain ones of the specific control inputs required to complete the key event included in the practice game scenario.

20. The method of claim 15, further includes providing feedback in substantial real time on a progress made by the player in the practice game scenario, the feedback includes input metrics identified for the inputs required for the practice game scenario, the input metrics of the player used to determine input skills gained, and overall performance of the player.

21. The method of claim 20, wherein providing the feedback further includes,
identifying the input metrics for the inputs provided by the player;
categorizing the inputs in accordance to the input metrics identified, wherein each input metric is assigned a relative weight that correlates with a level of difficulty experienced by the player when providing the inputs; and
providing the feedback to the player in accordance to the performance of the player for each category of input metrics identified from the inputs.

22. The method of claim 21, wherein the feedback identifies specific ones of the categories of the inputs where the player can benefit from practicing, and
wherein providing the feedback further includes generating and presenting one or more additional practice game scenarios targeting the inputs for each of the specific ones of the categories to assist the player to master the inputs for the specific ones of the categories.

23. The method of claim 21, wherein the feedback provided to the player is specific and is customized to the player based on the performance of the player in the practice game scenario presented to the player, and
wherein the feedback includes providing a visual representation of the progress made by the player for each input metric identified from the inputs provided by the player.
